(19) United States
(12) Patent Application Publication
(10) Pub. No.: US 2015/0292951 A1
(43) Pub. Date: Oct. 15, 2015

(54) MONITORING SYSTEM AND MONITORING METHOD

(71) Applicant: MITSUBISHI HEAVY INDUSTRIES, LTD., Tokyo (JP)

(72) Inventors: Tomohiro HOSHINO, Tokyo (JP); Tomoya MORIOKA, Tokyo (JP); Takahiro YAMADA, Tokyo (JP)

(21) Appl. No.: 14/580,581

(22) Filed: Dec. 23, 2014

(30) Foreign Application Priority Data
Apr. 15, 2014 (JP) 2014-083695

(51) Int. Cl. G01J 9/00; G01J 1/42; G01J 1/02; G01N 21/84

(52) U.S. Cl. CPC G01J 9/00; G01N 21/84; G01J 1/42; G01J 1/0214; G01N 2201/12

(57) ABSTRACT

A brightness time change of the target object is analyzed and a periodic brightness change is extracted. By the matching with a database which includes data of a candidate of the target object, the features of the target object are estimated. If even the brightness data can be acquired even if the resolution of the optical observation is low, the features and states of the target object can be estimated.

### TECHNICAL FIELD

The present invention is related to a monitoring system and a monitoring method.

### BACKGROUND ART

Even if a defect has occurred after launching an artifact such as an artificial satellite from the ground, it is extremely difficult or impossible to perform maintenances such as direct inspection of the state of the artifact, investigation of a cause and a repairing. Of the artifacts, there is one which has a checking function and a backup function. However, a support by ground staffs through the communication with a ground station is basically needed for the above maintenances. Especially, when the defect has occurred in the communication function of the artifact, the ground staffs cannot know even the current situation of the artifact.

However, there is a case where it is possible to know the state of the artifact even partially, by optically observing the artifact which orbits the earth, from the ground.

FIG. 1 is a diagram conceptually showing a system which optically observes the artifact orbiting the earth from the ground. FIG. 1 shows an optical observation system 10, a low earth orbit 11, a low earth orbit satellite 12, a medium earth orbit 13, a medium earth orbit satellite 14, a geostationary orbit 15, a geostationary orbit satellite 16 and an observation range 17. The low earth orbit 11 shows 80 km to 2000 km, the medium earth orbit 13 shows 2000 km to 35000 km, and the geostationary orbit 15 shows about 35000 km to 37000 km.

In an example of FIG. 1, the optical observation system 10 is arranged on the ground. The substantial observation range 17 of a general optical observation system 10 covers the so-called low earth orbit 11, namely, the low earth orbit satellite 12 which orbits the earth above about thousands of kilometers from the ground. However, the resolution necessary to confirm the shape and attitude of the geostationary orbit satellite cannot be achieved, even if it is tried to observe the so-called geostationary orbit satellite 16 which orbits the earth on the so-called geostationary orbit 15 above about 36000 kilometers from the ground by the optical observation system 10 on the ground.

In conjunction with the above description, Patent Literature 1 (JP 2002-220098A) discloses a method of detecting an object (debris and so on the geostationary orbit) which conducts a specific movement on the celestial. In the method of detecting according to Patent Literature 1, the object which conducts the specific movement is detected from image data obtained through an exposure period from a time t₀ to a time t_{T}, by driving a telescope in a predetermined drive method in the astronomical observation. In this detecting method, when it is supposed that the observation object is observed at a point Pₓ of the image at an exposure start time t₀, the trajectory of the object from the time t₀ to the time t_{T} is calculated on the image data and image data on the trajectory is added.

### CITATION LIST

[Patent literature 1] JP 2002-220098A

### SUMMARY OF THE INVENTION

An object of the present invention is to provide a monitoring system and a monitoring method which can estimate the features and states of a target object orbiting the earth, when the target object is optically observed from the ground, even if the orbit of the target object is the geostationary orbit or above. Other objects and new features will become clear from the description and the attached drawings.

According to an embodiment, the monitoring system includes an optical observation system and a data processing system. Here, the optical observation system optically observes a target object as an artifact which orbits the earth. The data processing system analyzes a brightness time change of the target object based on the observation result, extracts a periodic brightness change of the target object, and estimates the state of the target object.

According to an embodiment, the monitoring method includes optically observing a target object as an artifact which orbits the earth, analyzing a brightness time change of the target object based on the observation result, and extracting a periodic brightness change of the target object based on the analysis result.

According to the embodiments, the features and state of the target object can be estimated, when the brightness data of the target object can be acquired even if the resolution of the optical observation is low because a distance to the target object is too far.

### BRIEF DESCRIPTION OF THE DRAWINGS

FIG. 1 is a diagram showing a conventional system which optically observes an artifact which orbits the earth from the ground.

FIG. 2 is a block diagram schematically showing the configuration example of a monitoring system according to the present invention.

FIG. 3 is a flow chart showing the configuration example of a monitoring method of the present invention.

FIG. 4A is a graph showing an example of a brightness time change in the present invention.

FIG. 4B is a graph showing an example when frequency filtering processing is performed to the brightness time change in the present invention.

FIG. 5A is a graph showing a principle of extraction of a periodic brightness change in the present invention.

FIG. 5B is another graph showing the principle of extraction of the periodic brightness change in the present invention.

FIG. 6A is a diagram showing an example of shape data of a target object which has been stored in a light curve estimation database of the present invention.

FIG. 6B is a diagram showing another example of reflection characteristic data of the target object which has been stored in the light curve estimation database of the present invention.

FIG. 6C is a diagram showing another example of attitude data of the target object which has been stored in the light curve estimation database of the present invention.

FIG. 7A is a graph showing an example of the extraction result of the periodic brightness change in the present invention.

FIG. 7B is a graph showing an example of a detected extraordinary event in the periodic brightness change obtained in the present invention.

FIG. 7C is a diagram showing an example of a cause of the detected extraordinary event in the periodic brightness change obtained in the present invention.

FIG. 7D is a graph showing another example of the detected extraordinary event in the periodic brightness change obtained in the present invention.

FIG. 7E is a diagram showing another example of a cause of the detected extraordinary event in the periodic brightness change obtained in the present invention.

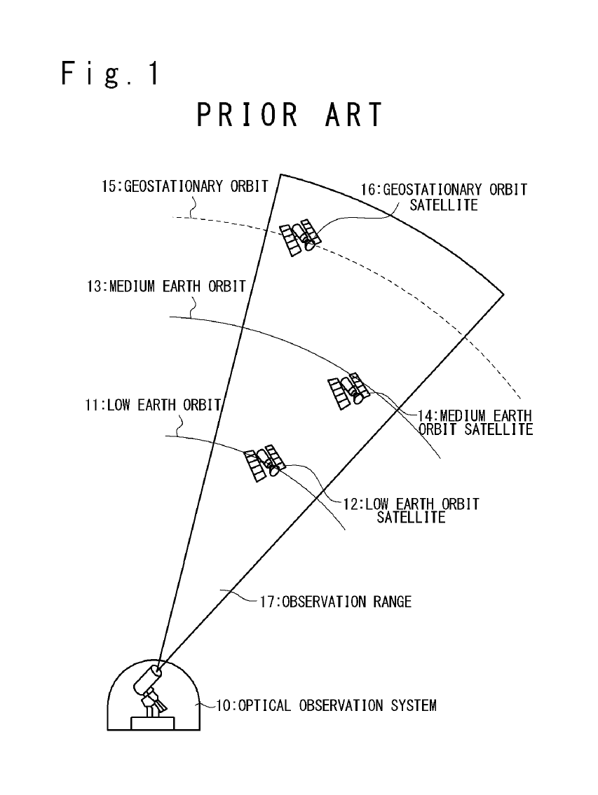

### DESCRIPTION OF EMBODIMENTS

Hereinafter, a monitoring system and a monitoring method according to embodiments of the present invention will be described below with reference to the attached drawings.

### First Embodiment

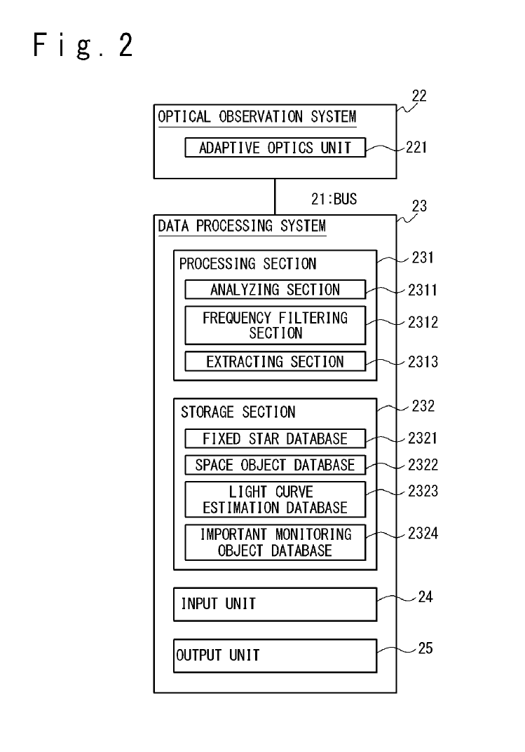

FIG. 2 is a block diagram showing a configuration example of the whole of monitoring system according to a first embodiment of the present invention. Referring to FIG. 2, the configuration of the monitoring system in the present embodiment will be described.

As shown in FIG. 2, the monitoring system includes a bus 21, an optical observation system 22 and a data processing system 23.

The optical observation system 22 has an adaptive optics unit 221.

The data processing system 23 has a processing section 231, which includes an analyzing section 2311, a frequency filtering section 2312 and an extracting section 2313.

The data processing system 23 further has a storage section 232, which has a fixed star database 2321, a space object database 2322, a light curve estimation database 2323 and an important monitoring object database 2324.

The fixed star database 2321 stores data of fixed stars whose brightness can be used as a reference. The space object database 2322 stores data of artifacts which orbit the earth. The light curve estimation database 2323 stores data showing a relation of a feature of a periodicity of the brightness time change, i.e., a periodic brightness change, a shape and attitude of each of target objects, and a feature of a reflectivity of each of surface materials. The important monitoring object database 2324 stores a list of objects determined as important monitoring objects of the target objects and various data of them.

The connection relation of the components shown in FIG. 2 will be described. The bus 21 is connected with the optical observation system 22 and the data processing system 23. In other words, the optical observation system 22 and the data processing system 23 can communicate with each other freely through the bus 21.

The operation of each of the components shown in FIG. 2 will be described.

The optical observation system 22 is installed on the ground and optically observes the sky. The adaptive optics unit 221 removes an influence of the atmosphere from the monitoring result of the optical observation system 22 by optical compensation.

The processing section 231 executes a predetermined program which is supplied from the storage section 232 and an input unit 24, to realize various functions. Note that in order to realize the various functions, the processing section 231 may refer to various data supplied from the storage section 232 and the input unit 24 and may use a part of the storage section 232 as a memory area.

As one function of the processing section 231, the analyzing section 2311 receives data acquired from the optical observation system 22 through the bus 21. In order to make a fixed star and a target object clear, the analyzing section 2311 carries out a matching operation of each data by using the fixed star database 2321. After that, the analyzing section 2311 analyzes brightness time changes of the target object and a reference fixed star.

As one function of the processing section 231, the frequency filtering section 2312 removes an influence of the atmosphere by carrying out the frequency filtering processing to data showing a brightness time change obtained optically from the target object.

as one function of the processing section 231, the extracting section 2313 extracts a periodicity of the brightness data based on the result of the analysis.

The input unit 24 inputs a selected observation object and so on. Also, the input unit 24 may input various programs to be executed by the processing section 231 from a predetermined recording medium.

The output unit 25 outputs the result of monitoring, extraction, and analysis by the optical monitoring system.

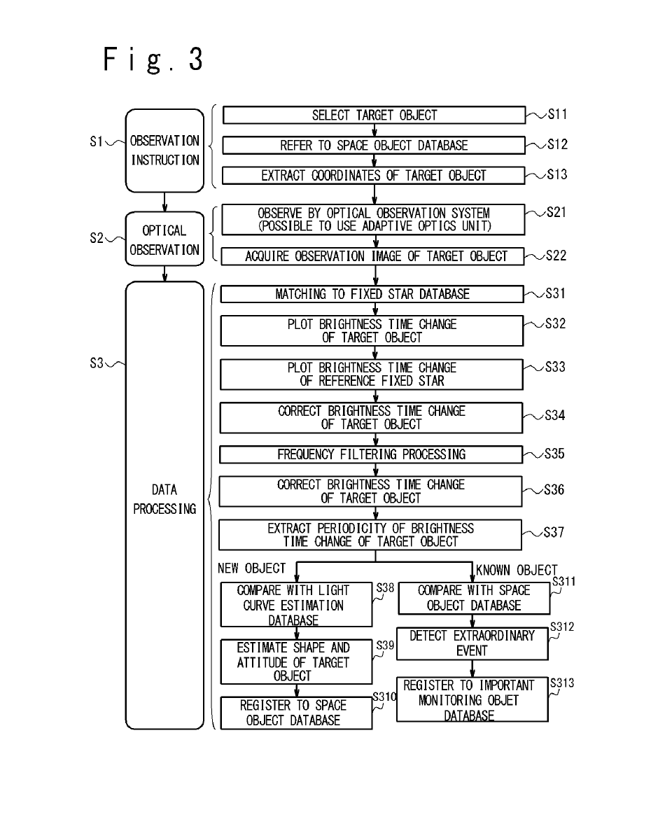

FIG. 3 is a flow chart showing an overall operation example of the monitoring method of present invention. With reference to FIG. 3, the monitoring method of the present invention, i.e. the operation of the monitoring system of the present invention will be described.

The flow chart shown in FIG. 3 contains three processes roughly. In a first process S1, an observation instruction is issued. In a second process S2, an optical observation is carried out. In a third process S3, data processing is carried out.

The first process S1 contains three steps of the flow chart shown in FIG. 3. At a step S11 of the first process, a target object is selected. At a step S12 of the first process, the space object database 2322 is referred to. At a step S13 of the first process, the coordinate data of the target object is extracted.

The second process S2 contains two steps of the flow chart shown in FIG. 3. At a step S21 of the second process, the target object is monitored by the optical observation system 22 using the adaptive optics unit 221. At a step S22 of the second process, an observation image is acquired.

The third process S3 contains 13 steps of the flow chart shown in FIG. 3. At a step S31 of the third process, the matching of the observation image to the fixed star database 2321 is carried out. At a step S32 of the third process, the brightness time change of the target object is plotted. At a step S33 of the third process, the brightness time change of the reference fixed star is plotted. At a step S34 of the third process, the brightness time change of the target object is corrected. At a step S35 of the third process, the frequency filtering processing is carried out. At a step S36 of the third process, brightness data of the target object is extracted. At a step S37 of the third process, the periodicity of brightness time change of the target object is extracted. As this result, whether or not the attitude control of the target object is being carried out can be estimated, and when the attitude control is not carried out, the target object can be considered to be not operated. The subsequent steps are different based on whether or not the target object is a new observation object. In case of the object (hereinafter, to be referred to as a “new object” or “unknown object”) for which the extraction of the brightness data has not been carried out so far, at a step S38 of the third process, comparison with the light curve estimation database 2323 is carried out. At a step S39 of the third process, the shape, the attitude, and the surface material of the target object are estimated. At a step S310 of the third process, the target object is registered on the space object database 2322. In case of the object (known object) for which the extraction of the brightness data has been carried out so far, at a step S311 of the third process, comparison with the data acquired at previous times is carried out. At a step S312 of the third process, occurrence or non-occurrence of an extraordinary event of the target object is detected. At a step S313 of the third process, when the occurrence of the extraordinary event is detected at the step S312 of the third process, the target object is registers on the important monitoring object database 2324.

The first process S1 to third process S3 are executed in this order. Also, each of the step S11 to the step S13 of the first process, the step S21 to the step S22 of the second process, and the step S31 to the step S37 of the third process is executed in this order. The processing contents differ depending on the new (unknown) object or the known object, in the step S38 to the step S310 and the step S311 to the step S313. The above steps will be described in detail.

At the step S11 of the first process, the target object is selected. The selection may be carried out by a user of the monitoring system or the data processing system 23 may carry out according to a predetermined condition and a predetermined list. Here, the predetermined list and the predetermined condition may be contained in the space object database 2322 or may be contained in the important monitoring object database 2324.

At the step S12 of the first process, the data processing system 23 refer to the space object database 2322 to acquire various data required to optically observe the selected target object from the ground. It is especially desirable that data indicating on what orbit the selected target object is orbiting the earth is contained in this data. Note that the selected target object may be a new object which is unregistered to the space object database 2322.

At the step S13 of the first process, the processing section 231 extracts or calculates coordinate data of a position of the selected target object used when the selected target object is optically observed, from the various data acquired at the step S12 of the first process. At this time, it is desirable to calculate a time zone in which the optical observation system 22 can observe the selected target object, in addition to the coordinates data

At the step S21 of the second process, the optical observation system 22 optically observes the target object. At that time, for the purpose to remove an influence of the atmosphere, the adaptive optics unit 221 is sometimes used.

At the step S22 of the second process, the optical observation system 22 acquires an image. This observation may be supported by the processing section 231. Also, it is desirable that this observation of the same target object is repeated regularly or irregularly.

At the step S31 of the third process, the processing section 231 refers to the fixed star database 2321 which is previously stored in the storage section 232. In this case, it is especially desirable that the processing section 231 specifies a fixed star near the target object in the image which has acquired at the step S22 of the second process, and acquires various data of the specified fixed star. For example, it is desirable that the various data include coordinate data of the fixed star, a direction of the fixed star when being seen from the earth, a magnitude of the fixed star, an apparent brightness of the fixed start, and a period of light variation when the fixed star is a variable star in the comparable form with the observation result of the target object.

At the step S32 of the third process, the processing section 231 plots data showing a time change of estimated brightness of the target object. A graph may be produced in which the estimated brightness of the target object and an elapse of the time are plotted on the 2-dimensional coordinate system as an example of such data. However, an influence of the fluctuation of atmosphere which is not possible to correct by the adaptive optics unit 221 and noise data derived from the observation environment and so on are sometimes contained in the data obtained at this step.

At the step S33 of the third process, the brightness time change of a reference fixed star is plotted by the processing section 231.

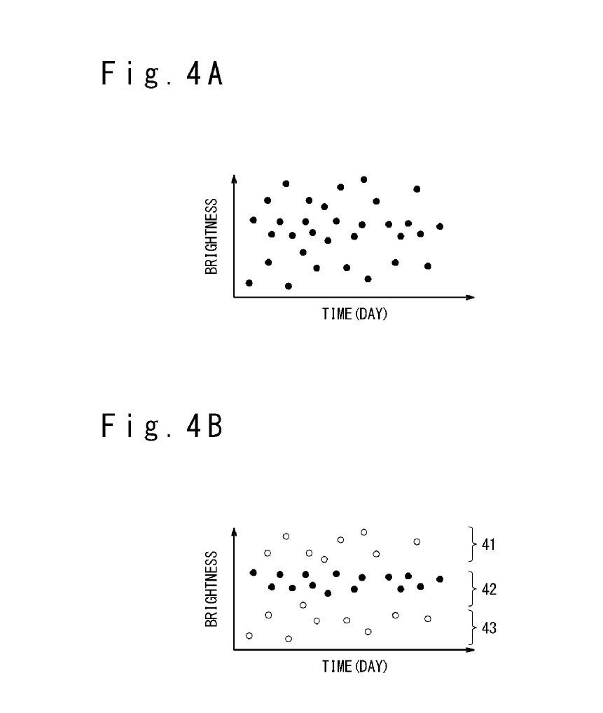

FIG. 4A is a graph showing an example of the plotting result of the brightness time change in the present invention. In the graph shown in FIG. 4A, the horizontal axis shows time and the vertical axis shows the estimated brightness of the target object.

At the step S34 of the third process, the processing section 231 compares the estimated brightness of the target object plotted at the step S32 of the third process and the brightness of the reference fixed star plotted at the step S33 of the third process to determine a rate of the brightness time change which is regarded as the influence of the atmosphere and the influence of the observation environment. Thus, the processing section 231 corrects the brightness of the target object based on the rate of the brightness time change.

At the step S35 of the third process, the frequency filtering section 2312 applies predetermined frequency filtering processing to the data produced at the step S34 of the third process, to classify the brightness data of the target object and the brightness data derived from things other than the target object.

FIG. 4B is a graph showing an example of the frequency filtering of the brightness in the present invention. The graph shown in FIG. 4B is identical to a result when the frequency filtering section 2312 applied the following changes to the graph shown in FIG. 4A. That is, the plot data is classified to a first group 41, a second group 42 and a third group 43 based on brightness ranges, and the plot data which belong to the first group 41 and the third group 43 are shown in white. In an example shown in FIG. 4B, it is estimated that the second group 42 is the brightness data of the target object, and the plot data belonging to the first group 41 and the third group 43 are estimated to be noise data.

At the step S36 of the third process, the analyzing section 2311 removes the noise data from the data produced at the step S34 of the third process of FIG. 3 according to the classification carried out at the step S35 of the third process, to extract the brightness data of the target object.

At the step S37 of the third process, the extracting section 2313 extracts the periodicity from the time change of the estimated brightness of the target object. Whether or not an attitude control of the target object is being carried out can be checked based on the extraction result, and it is possible to estimate that the target object is in the operation state when the attitude control is being carried out.

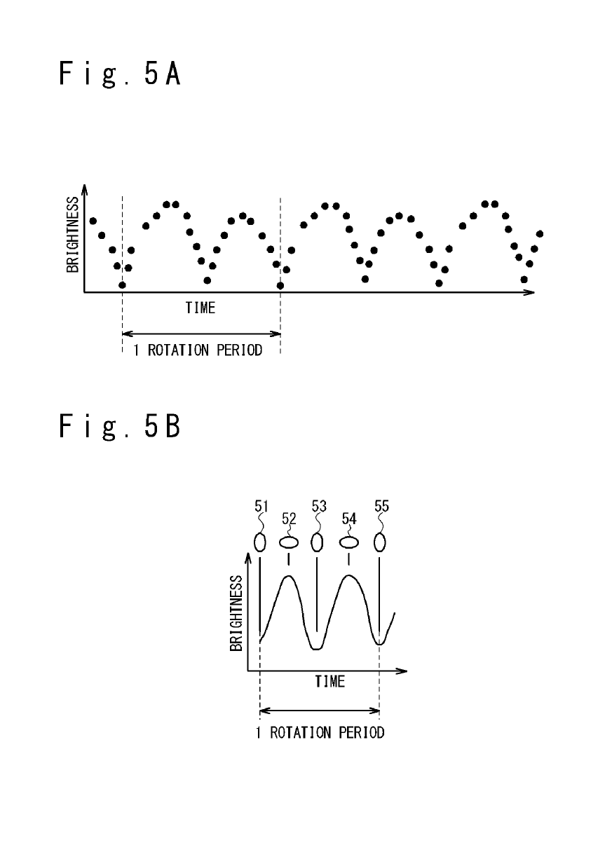

FIG. 5A is a graph showing the principle of extracting the periodicity of time change of the brightness in the present invention. In the graph shown in FIG. 5A, the horizontal axis shows time and the vertical axis shows the estimated brightness of the target object. In an example shown in FIG. 5A, a set of a large mountain and a small mountain shows a rotation period of the target object.

FIG. 5B is a different graph showing the principle of extracting the period of time change of the brightness in the present invention. In an example of the graph shown in FIG. 5B, the horizontal axis shows time and the vertical axis shows the estimated brightness of the target object. Moreover, a first attitude 51, a second attitude 52, a third attitude 53, a fourth attitude 54 and a fifth attitude 55 of the target object are shown in FIG. 5B. These attitudes show the attitudes of the target object at the time which the target object is imaged.

In an example shown in FIG. 5B, the brightness increases in the second attitude 52 and the fourth attitude 54 in which the width of the target object is maximum. On the contrary, the brightness decreases in the first attitude 51, the third attitude 53 and the fifth attitude 55 in which the width of the target object is minimized.

As shown in the example of FIG. 5B, when the target object rotates while the target object orbits the earth, the brightness of the target object in the view from the ground changes depending on the attitude of the target object, i.e. a phase of the rotation movement. The reason is in that a rate of an area of a portion, which reflects the sun light and so on well, of the surface of the target object changes according to the rotation of the target object. The period of this change of brightness substantively coincides with the rotation period.

### Second Embodiment

The process from the step S11 of the first process to the step S37 of the third process, of the plurality of processes in the monitoring method of the present invention, has been described as the first embodiment. The subsequent portion will be described as a second embodiment. Because the configuration of the monitoring system in the second embodiment is same as that of the first embodiment, the detailed description is omitted.

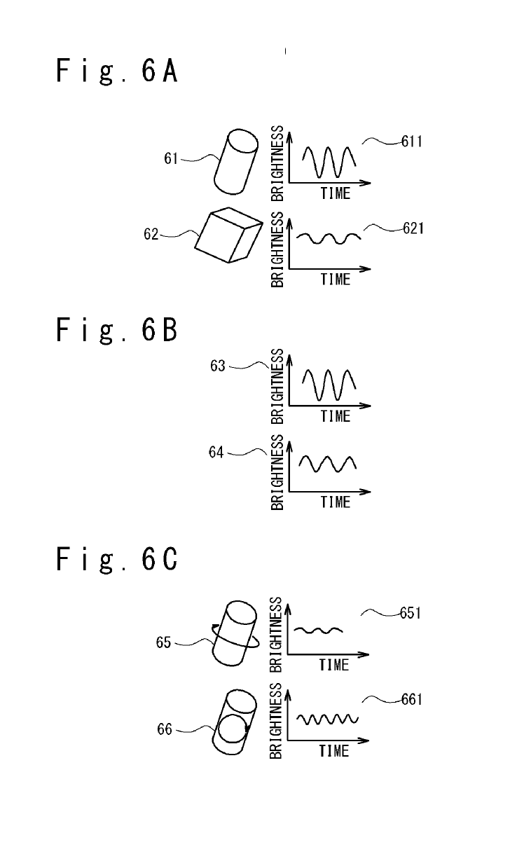

At the step S38 of the third process, the processing section 231 compares the brightness of the target object extracted at the step S37 of the third process and data stored in the light curve estimation database 2323 of the storage section 232 when the data obtained about the target object is unregistered to the space object database 2322, i.e. when a new object is observed. Specific examples of the contents of the light curve estimation database 2323 will be described with reference to FIG. 6A to FIG. 6C. Note that the examples shown in FIG. 6A to FIG. 6C are schematically showing to simplify the description. The light curve estimation database 2323 is produced actually based on the optical measurement and the result of computer simulation.

FIG. 6A is a diagram showing an example of the shape data of the target object which is contained in the light curve estimation database 2323 in the present invention. FIG. 6A contains a cylindrical shape 61, a first graph 611 corresponding to the cylindrical shape 61, a rectangular parallelepiped shape 62 and a second graph 621 corresponding to the rectangular parallelepiped shape 62. The first graph 611 shows an example of a pattern of the brightness time change estimated when the target object has the cylindrical shape 61. In the same way, the second graph 621 shows an example of a pattern of the brightness time change estimated when the target object has the rectangular parallelepiped shape 62.

FIG. 6B is a diagram showing another example of the reflection characteristic data of the target object which is contained in the light curve estimation database 2323 in the present invention. FIG. 6B contains a first graph 63 corresponding to a predetermined first material and a second graph 64 corresponding to a predetermined second material. The first graph 63 shows an example of the brightness time change pattern estimated when the surface of the target object is formed of the first material. In the same way, the second graph 64 shows an example of the brightness change pattern estimated when the surface of the target object is formed of the second material.

FIG. 6C is a diagram showing an example of the attitude data of the target object which is contained in the light curve estimation database 2323 in the present invention. FIG. 6C contains a first attitude 65 in which the target object of the cylindrical shape rotates around a line symmetrical axis, a first graph 651 corresponding to the first attitude 65, a second attitude 66 in which the target object rotates around a line orthogonal to the line symmetrical axis, and a second graph 661 corresponding to second attitude 66. The first graph 651 shows an example of the brightness change pattern estimated when the target object rotates around the line symmetrical axis. In the same way, the second graph 661 shows an example of the brightness change pattern estimated when the target object rotates around the orthogonal to the line symmetrical axis.

At the step S39 of the third process, the processing section 231 calculates the matching between the observation result of the brightness time change of the target object and data of the light curve estimation database 2323, and estimates the features of the target object such as the shape, the attitude and the surface material based on the matching result. The estimation which is based on the examples of FIG. 6A to FIG. 6C will be described below.

Based on the example shown in FIG. 6A, the shape of the target object is more similar to the cylindrical shape 61, when the amplitude of the brightness change is larger and an average is smaller. Also, it is possible to estimate that the shape of the target object is more similar to the rectangular parallelepiped shape 62, when the amplitude of the brightness change is smaller and the average is larger.

Based on the example shown in FIG. 6B, the surface reflection characteristics of the target object are more similar to that of the first material, when the amplitude of the brightness time changes is larger. Also, it is possible to estimate that the surface reflection characteristic of the target object is similar to that of the second material, when the amplitude of the brightness changes is smaller.

Based on the example shown in FIG. 6C, the attitude of the target object is more similar to the first attitude, when the amplitude of the brightness time change is smaller and the period of the brightness time changes is longer. Oppositely, it is possible to estimate that the attitude of the target object is more similar to the second attitude, when the amplitude of the brightness time change is larger and the period of the brightness time changes is shorter.

Actually, in the light curve estimation database 2323, it is possible to carry out more detailed matching by using more measurement values or simulation results, so that it becomes able to more specifically estimate and narrow down the shape of the target object.

At the step S310 of the third process, the processing section registers the result estimated at the step S39 of the third process on the space object database 2322 of the storage section 232.

### Third Embodiment

The processing to the step S310 of the third process of the plurality of steps contained in the monitoring method of the present invention has been described as the first embodiment or the second embodiment. The subsequent steps will be described as a third embodiment. Note that the monitoring system of the present invention to be used at the present embodiment is the same as that of the first embodiment. Therefore, further detailed description is omitted.

At the step S311 of the third process, when the target object have already registered on the space object database 2322, i.e. when the known object has been observed once again, the processing section 231 compares the estimated brightness of the object body extracted at the step S37 of the third process and the brightness data registered on the space object database 2322 of the storage section 232.

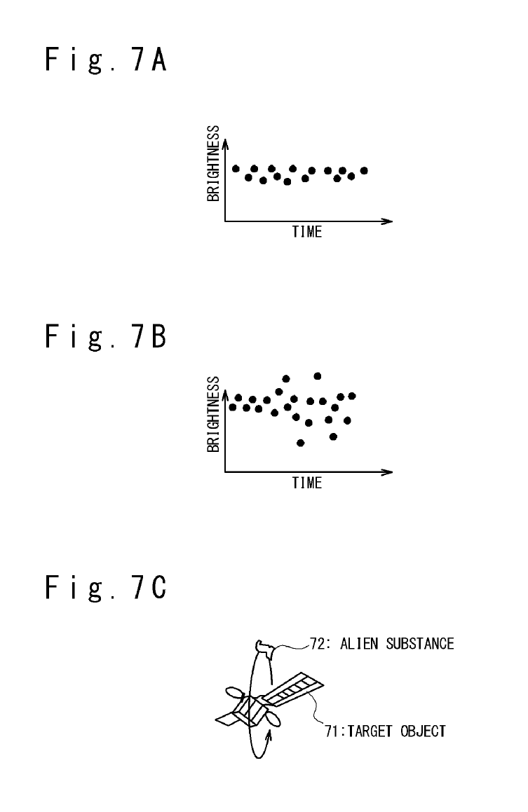

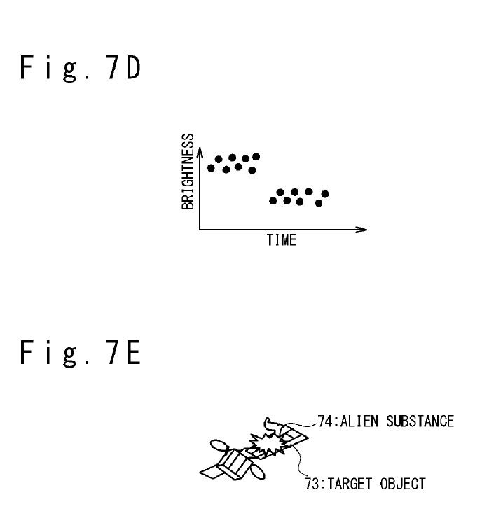

At the step S312 of the third process, when there is a difference from the brightness information registered on the space object database 2322, the processing section 231 detects an extraordinary state as shown in FIG. 7 and can carry out the estimation.

At the step S313 of the third process, the known object from which an extraordinary event can be detected at the step S312 of the third process is registered on the important monitoring object database 2324 of the storage section 232 so as to continuously monitor the object. The extraordinary event which can be detected will be described by using two examples.

A first example will be described with reference to FIG. 7A to FIG. 7C. FIG. 7A is a graph showing an example of a usual extraction result of the periodic brightness change in the present invention. FIG. 7B is a graph showing an example of an extraordinary event which occurs in the periodic brightness change which can be detected in the present invention.

In two graphs shown in FIG. 7A and FIG. 7B, the horizontal axis shows time and the vertical axis shows brightness. In the graph shown in FIG. 7A, the brightness continues to periodically change to show the usual state of the target object. Oppositely, in the graph shown in FIG. 7B, the amplitude of the brightness values changes greatly from the way. The processing section 231 detects such a change to be extraordinary and outputs the result to the output unit 25.

FIG. 7C is a diagram showing an example of an extraordinary cause that the periodic brightness change detected in the present invention occurs. Alien substance 72 is orbiting around the target object 71 in the example shown in FIG. 7C. When this alien substance 72 has begun to orbit around the target object 71, the brightness of the target object 71 is more strongly observed due to the reflection light from the alien substance 72, and oppositely, the brightness of the target object 71 is more weakly observed by blocking the light by the alien substance 72. That is, the possibility that the extraordinary cause in the example shown in FIG. 7B is a phenomenon in an example shown in FIG. 7C can be estimated.

A second example will be described with reference to FIG. 7A, FIG. 7D and FIG. 7E. FIG. 7D is a graph showing another extraordinary example in which the periodic brightness change occurs which can be detected in the present invention.

In the graph shown in FIG. 7D, the horizontal axis shows time and the vertical axis shows brightness. In the graph shown in FIG. 7D, the brightness average decreases greatly from the middle of the observation. The processing section 231 detects such a change as an extraordinary event, and outputs the result to the output unit 25.

FIG. 7E is a diagram showing another example of an extraordinary cause by which the periodic brightness change occurs which can be detected in the present invention. In an example shown in FIG. 7E, the target object 73 damages partially through the crash with an alien substance 74. In this example, a part of a solar panel having an especially large area is damaged in the target object 73. Therefore, the brightness of the target object 73 is greatly weakly observed since the crash. That is, the extraordinary cause in the example shown in FIG. 7D is estimated to be possibly a phenomenon in the example shown in FIG. 7E.

Although two extreme examples for simplification are described above, it actually become possible to estimate the detailed causes by using the monitoring system and the monitoring method according to the present invention by storing more causalities in the database previously.

As above, the present invention accomplished by the inventor has been specifically described with reference to the embodiments. However, the present invention is not limited to the embodiments and various modifications are possible in a range not deviating from the scope of the present invention. Also, the above-mentioned embodiments can be freely combined with each other be freely in the range without contradicting technically.

This application claims a priority based on a Japanese Patent Application No. JP 2014-083695. The disclosure thereof is incorporated herein by reference.

What is claimed is:

1. A monitoring system comprising:
an optical observation system configured to optically observe a target object which is an artifact orbiting the earth; and
a processing section configured to analyze a brightness time change of said target object based on an observation result.

2. The monitoring system according to claim 1, further comprising:
an important monitoring object database in which the target object that a periodicity of the brightness time change is extracted is registered as an important monitoring object by said processing section,
wherein the observation and analysis of the important monitoring object are continued, and
wherein said processing section further extracts a change of the periodicity of the brightness time change of the important monitoring object.

3. The monitoring system according to claim 1, further comprising:
a light curve estimation database which stores data showing a relation of a feature of a periodicity of the brightness time change and a feature of the target object,
wherein said processing section estimates the feature of said target object by matching of said light curve estimation database and the observation result.

4. The monitoring system according to claim 3, wherein said light curve estimation database stores data showing the feature of the periodicity of the brightness time change which is related with all or a part of the shape, attitudes and reflectivity which are the features of said target object, and
wherein the estimated feature of said target object includes all or a part of the shape, attitudes and reflectivity of said target object.

5. The monitoring system according to claim 3, further comprising a space object database which stores data showing an artifact which orbits the earth,
wherein said the processing section specifies said target object based on the estimation result by referring to said space object database.

6. The monitoring system according to claim 3, further comprising a space object database which stores data showing an artifact which orbits the earth,
wherein said processing section registers said target object on said space object database based on the estimation result.

7. The monitoring system according to claim 1, wherein said optical monitoring system is provided on the ground and comprises an adaptive optics unit configured to remove an influence of atmosphere based on the observation result.

8. A monitoring method comprising:
optically observing a target object as an artifact which orbits the earth; and
analyzing a brightness time change of said target object based on the observation result.

9. The monitoring method according to claim 8, further comprising:
registering said target object, from which a periodicity of the brightness time change is extracted, on an important monitoring object database as an important monitoring object;
continuing the observation and analysis to the important monitoring object; and
extracting a change of the periodicity of the brightness time change of the important monitoring object.

10. The method of watching according to claim 8, further comprising:
referring to a light curve estimation database which stores data showing a relation of a feature of the periodicity of the brightness time change and a feature of said target object; and
estimating the feature of said target object by matching between said light curve estimation database and the observation result.

11. The method of watching according to claim 10, wherein said light curve estimation database stores data showing the feature of the periodicity of the brightness time change which is related with all or a part of the shape, attitudes and reflectivity which are the features of said target object, and
wherein the estimated feature of said target object includes all or a part of the shape, attitudes and reflectivity of said target object.

12. The monitoring method according to claim 10, further comprising:
referring to a space object database which stores data showing an artifact which orbits the earth; and
specifying said target object based on the estimation result by referring to said space object database.

13. The monitoring method according to claim 10, further comprising:
registering said target object on a space object database which stores data showing an artifact which orbits the earth.

14. The monitoring method according to claim 8, wherein said observing comprises:
observing by an optical monitoring system provided on the ground; and
removing an influence of atmosphere from the observation result.
